(19) United States
(12) Patent Application Publication
(10) Pub. No.: US 2022/0364969 A1
(43) Pub. Date: Nov. 17, 2022

(54) GAS ADSORPTION AMOUNT MEASUREMENT DEVICE AND GAS ADSORPTION AMOUNT MEASUREMENT METHOD

(71) Applicant: MicrotracBEL Corp., Osaka-shi, Osaka (JP)

(72) Inventor: Kazuyuki NAKAI, Osaka-shi, Osaka (JP)

(73) Assignee: MicrotracBEL Corp., Osaka-shi, Osaka (JP)

(21) Appl. No.: 17/633,559

(22) PCT Filed: Aug. 19, 2020
(86) PCT No.: PCT/JP2020/031199

§ 371 Date: Feb. 7, 2022

(30) Foreign Application Priority Data
Aug. 19, 2019 (JP) 2019-149861

(51) Int. Cl. G01N 7/04

(52) U.S. Cl. CPC G01N 7/04

(57) ABSTRACT

A gas adsorption amount measurement device, which is an example of an embodiment of the present invention, comprises at least one sample tube, a reference tube, and a control unit. The control unit is configured to measure, using adsorption gas, reference volumes Vd_{st,ads} of a free space of the sample tube not having a sample and reference volumes Vd_{ref,ads} of a free space of the reference tube, respectively and to calculate a gas adsorption amount of the sample using the reference volumes Vd_{st,ads}, Vd_{ref,ads}.

### TECHNICAL FIELD

The present invention relates to a gas adsorption amount measurement apparatus and a gas adsorption amount measurement method, and more particularly to a measurement apparatus and a measurement method according to a constant volume method.

### BACKGROUND

In the related art, gas adsorption amount measurement apparatuses that measure the adsorption isotherms of materials by the constant volume method have been widely known. Adsorption isotherms are one of the important basic physical properties that can provide information on the specific surface area and pore distribution of materials. They are measured using adsorption gases such as nitrogen and argon at temperatures such as liquid nitrogen (LN₂:77 K) and liquid argon (LAr:87 K) temperatures. For example, Patent Document 1 discloses an adsorption property measurement apparatus that calculates the gas adsorption amount of a powder material by immersing a glass sample tube containing the powder material in a Dewar bottle filled with liquid nitrogen, supplying the sample tube with nitrogen, and measuring the pressure change in the sample tube.

Generally, in the measurement of the gas adsorption amount by the constant volume method, the sample tube containing the sample is immersed in a refrigerant container such as a Dewar bottle filled with liquid nitrogen or other refrigerant before the adsorption amount measurement, and the reference volume of free space is measured using helium, which has difficulty adsorbing to the sample. When the sample is a material with micropores, such as zeolite or activated carbon, the reference volume of free space may be measured after the gas adsorption amount is measured. This measurement also uses helium.

If the liquid nitrogen in the Dewar bottle vaporizes during the measurement of the adsorption characteristics and the liquid level gradually decreases, the reference volume of the free space changes, making it difficult to accurately measure the amount of gas adsorption amount. For this reason, efforts have been made to suppress such volume changes, such as using a liquid level sensor to raise the Dewar bottle in stages.

One proposed method makes use of the phenomenon that the reference volume of free space momentarily changes as the liquid level of liquid nitrogen gradually decreases (see, for example, Patent 2 and Non-Patent Document 1). In this method, the reference tube is immersed in liquid nitrogen alongside the sample tube, and the reference volume of the free space of each tube is measured before the adsorption amount measurement. Then, the volume change rate is calculated from the internal pressure of the reference tube that changes every moment, and this change rate is used to calculate the volume of the free space of the sample tube.

### CITATION LIST

### Patent Literature

Patent Document 1: JP 6037760 B

Patent Document 2: JP 3756919 B

### Non-Patent Literature

Non-Patent Document 1: Masayuki Yoshida and Kazuyuki Nakai, “Development of New Method for Measuring Dead Volume in Constant Volume Adsorption Device”, Adsorption News, The Japan Society on Adsorption, Dec. 25, 2007, Vol. 21, No. 4 (December 2007), Volume No. 83, pp. 5-9

### SUMMARY

### Technical Problem

As described above, known gas adsorption amount measurement (including the techniques disclosed in Patent 2 and Non-Patent Literature 1) uses helium to measure the reference volume of free space in a sample tube. However, as the demand for helium increases and its resources decrease, the availability of helium is expected to become difficult. Therefore, in the near future, it will be essential to have a method to measure the reference volume of free space needed to calculate the gas adsorption amount, without using helium.

The purpose of the present invention is to provide an unprecedented gas adsorption amount measurement apparatus and gas adsorption amount measurement method that can measure the reference volume of the free space of a sample tube without using helium, and that can measure the gas adsorption amount with high accuracy using the volume.

### Solution to Problem

As a result of intensive studies to solve the above problems, the present inventors have found that a reference volume of a free space of a sample tube measured using an adsorption gas such as nitrogen can be applied to highly accurate gas adsorption amount measurement by using a reference tube. The gas adsorption amount measurement apparatus of the present invention is configured to measure the reference volume Vd_{st,ads} of the free space of a sample tube without the sample and the reference volume Vd_{ref,ads} of the free space of a reference tube using an adsorption gas, and calculate the gas adsorption amount of the sample using the reference volumes Vd_{st,ads} and Vd_{ref,ads}. The gas adsorption amount measurement apparatus of the present invention is an unprecedented apparatus that enables highly accurate gas adsorption amount measurement without the use of helium.

The gas adsorption amount measurement apparatus according to one aspect of the present invention is a gas adsorption amount measurement apparatus that includes at least one sample tube and measures the gas adsorption amount of the sample contained in the sample tube by supplying an adsorption gas to the sample tube, including: a reference tube for determining the volume of the free space of the sample tube; a piping section to which the sample tube, the reference tube, and the supply pipe of the adsorption gas are connected; a pressure gauge for measuring the pressure of the piping section, the sample tube, and the reference tube; a device for maintaining the temperature of the sample tube and the reference tube at a predetermined temperature; and a control unit, wherein the control unit is configured to measure the reference volume Vd_{st,ads} of the free space of the sample tube without the sample and the reference volume Vd_{ref,ads} of the free space of the reference tube under calibration conditions using the adsorption gas, calculates the volume change amount ΔVd_{ref(i)} from the reference volume Vd_{ref,ads} and the volume Vd_{ref,ads(i)} of the free space of the reference tube under the actual measurement conditions of the gas adsorption amount, calculates the volume Vd_{st,ads(i)} of the free space of the sample tube under the actual measurement conditions from the volume change amount ΔVd_{ref(i)} and the reference volume Vd_{st,ads}, and calculates the gas adsorption amount of the sample under the actual measurement conditions from the volume Vd_{st,ads(i)} and the volume Vd_{sam,ads(i)} of the free space of the sample tube containing the sample under the actual measurement conditions.

The method for measuring a gas adsorption amount according to one aspect of the present invention is a method for measuring a gas adsorption amount using at least one sample tube, and a reference tube for determining the volume of the free space of the sample tube, including: measuring the reference volume Vd_{st,ads} of the free space of the sample tube without a sample and the reference volume Vd_{ref,ads} of the free space of the reference tube under calibration conditions using an adsorption gas; calculating the volume change amount ΔVd_{ref(i)} from the reference volume Vd_{ref,ads} and the volume Vd_{ref,ads(i)} of the free space of the reference tube under the actual measurement conditions of the gas adsorption amount; calculating the volume Vd_{st,ads(i)} of the free space of the sample tube under the actual measurement conditions from the volume change amount ΔVd_{ref(i)} and the reference volume Vd_{st,ads}; and calculating the gas adsorption amount of the sample under the actual measurement conditions from the volume Vd_{st,ads(i)} and the volume Vd_{sam,ads(i)} of the free space of the sample tube containing the sample under the actual measurement conditions.

### Advantageous Effects of Invention

According to the gas adsorption amount measurement apparatus and gas adsorption amount measurement method of the present invention, the reference volume of the free space of a sample tube can be measured without using helium, and highly accurate gas adsorption amount measurement can be performed using the volume. In the apparatus and method of the present invention, instead of helium, an adsorption gas such as nitrogen is used to measure the reference volume of the free space of a sample tube. In addition, the apparatus and method of the present invention eliminate the need to measure the reference volume of the free space of a sample tube every time the gas adsorption amount is measured, as in the related art, and thus shorten the measurement time.

In addition, in the related-art method, when the sample is a material with micropores such as zeolite or activated carbon, helium may be trapped in the micropores, resulting in a decrease in measurement accuracy. However, the apparatus and method of the present invention do not use helium, so such a decrease in measurement accuracy will not occur. The related-art method overcomes this problem by measuring the free space using helium after the measurement of the adsorption amount, but there are several problems: the adsorption isotherm cannot be evaluated during the measurement, it takes time to evacuate the adsorption gas after the measurement, and the free space is measured assuming that the residual amount of adsorption gas is constant. The apparatus and method of the present invention can shorten the measurement time and improve the measurement accuracy, even for samples with micropores.

### BRIEF DESCRIPTION OF DRAWINGS

FIG. 1 is a configuration diagram of a gas adsorption amount measurement apparatus according to an embodiment of the present invention.

FIG. 2 illustrates a gas adsorption amount measurement method according to an embodiment of the present invention.

FIG. 3 is a flowchart illustrating an example of the procedure for measuring the reference volume of free space of a sample tube and a reference tube.

FIG. 4 is a flowchart illustrating an example of the procedure for measuring the gas adsorption amount of a sample (net absorption amount).

### DESCRIPTION OF EMBODIMENTS

Hereinafter, a gas adsorption amount measurement apparatus 10 according to an embodiment of the present invention will be described in detail with reference to the drawings. The gas adsorption amount measurement apparatus 10 is merely an embodiment, and the present invention is not limited thereto. In the present specification, the description of “substantially”, by using “substantially the same” as an example, means a case where the respective aspects are completely the same and a case where they are recognized as being substantially the same.

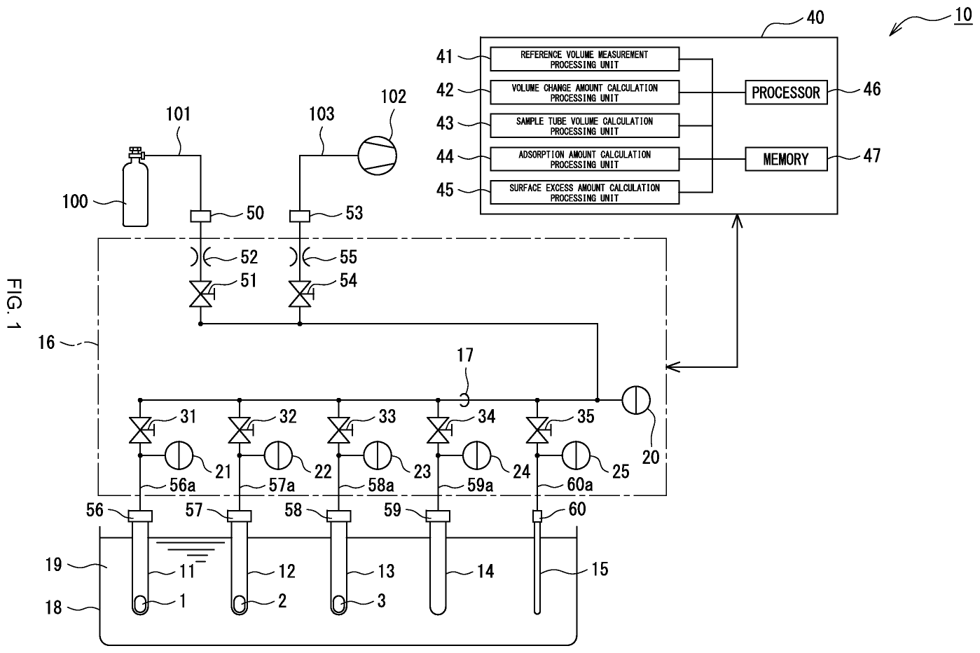

FIG. 1 is a configuration diagram of the gas adsorption amount measurement apparatus 10. As illustrated in FIG. 1, the gas adsorption amount measurement apparatus 10 includes a plurality of sample tubes 11, 12, and 13, and is configured to enable parallel measurement of the gas adsorption amounts of samples 1, 2, and 3 contained in the respective tube. In FIG. 1, the three sample tubes 11, 12, and 13 are illustrated, but the number of sample tubes is not particularly limited, and may be one, two, or four or more. The three sample tubes 11, 12, and 13 are the same and have substantially the same inner diameter. The samples 1, 2, and 3 are objects to be measured for the gas adsorption amount, and are, for example, powder materials.

The gas adsorption amount measurement apparatus 10 includes a reference tube 14 for determining the volume of the free space of the sample tubes 11, 12, and 13. A plurality of reference tubes 14 may be provided, but preferably one reference tube is provided regardless of the number of sample tubes. The reference tube 14 is the same as the sample tubes 11, 12, and 13, and has substantially the same inner diameter as each sample tube. In particular, the inner diameter of the portion immersed in a refrigerant 19 described later needs to be substantially the same. The gas adsorption amount measurement apparatus 10 includes a saturated vapor pressure tube 15 for actually measuring the saturated vapor pressure (P₀) of the adsorption gas. It may be the case that the gas adsorption amount measurement apparatus 10 does not include the saturated vapor pressure tube 15, and calculates the saturated vapor pressure (P₀) by measuring the temperature of the refrigerant 19 with a thermometer.

The gas adsorption amount measurement apparatus 10 includes a piping section 16 to which the sample tubes 11, 12, and 13, the reference tube 14, and a supply pipe 101 for the adsorption gas are connected, and a pressure gauge to measure the respective pressures of the piping section 16, the sample tubes 11, 12, and 13, and the reference tube 14. The number of the pressure gauge may be one, but preferably a plurality of pressure gauges are installed in the piping section 16. The pressure gauges include a pressure gauge 20 that measures the pressure in a reference volume portion S described below in the piping section 16, and pressure gauges 21, 22, 23, and 24 that measure the internal pressure of the sample tubes 11, 12, and 13, and the reference tube 14. The piping section 16 further includes a pressure gauge 25 to measure the internal pressure of the saturated vapor pressure tube 15.

The gas adsorption amount measurement apparatus 10 also includes a device that maintains the temperature of the sample tubes 11, 12, and 13 and the reference tube 14 at a predetermined temperature, and a control unit 40 that controls the operation of the apparatus and performs the gas adsorption amount measurement. The device includes, for example, a refrigerant container 18 that is filled with the refrigerant 19, and a lifting mechanism (not shown) that raises and lowers the refrigerant container 18. The refrigerant 19 is not particularly limited, but is generally liquid nitrogen or liquid argon. Hereinafter, unless otherwise specified, it will be assumed that the refrigerant 19 is liquid nitrogen.

The gas adsorption amount measurement apparatus 10 generally includes a housing that accommodates the piping section 16, the control unit 40, and other elements. The sample tubes 11, 12, and 13, the reference tube 14, the saturated vapor pressure tube 15, the refrigerant container 18, and other elements are attached to the housing. The gas adsorption amount measurement apparatus 10 (housing) is provided with a first connection 50 to which the supply pipe 101 extending from an adsorption gas supply source 100 is connected, and a second connection 53 to which an exhaust pipe 103 extending from an exhaust pump 102 is connected. An example of the adsorption gas supply source 100 is a nitrogen gas cylinder, and an example of the exhaust pump 103 is a vacuum pump.

The piping section 16 includes a plurality of pipes for connecting each of the sample tubes 11, 12, and 13, the reference tube 14, and the saturated vapor pressure tube 15 to the first connection 50 and the second connection 53. The piping section 16 includes a manifold 17 that combines a plurality of pipes, and multiple switching valves. The piping section 16 may include a second device that maintains the temperature of the manifold 17 at a predetermined temperature, and the temperature of the reference volume portion S, which is the internal space of the manifold 17, may be maintained at a certain temperature by the second device. The volume of the reference volume portion S is the standard for measuring the volume of free space such as the sample tube 11.

In the example shown in FIG. 1, switching valves 31, 32, 33, 34, 35, 51, and 54 are provided for the sample tubes 11, 12, and 13, the reference tube 14, the saturated vapor pressure tube 15, the first connection 50, and the second connection 53, respectively. By opening the switching valve 51, adsorption gas is introduced into the reference volume portion S enclosed by each switching valve in the piping section 16. For example, by opening the switching valve 31, adsorption gas is introduced into the sample tube 11. Each switching valve is configured to be operated under control of the control unit 40.

Since the gas adsorption amount measurement apparatus 10 does not use helium for measuring the free space volume, no helium supply source is connected. In other words, the gas adsorption amount measurement apparatus 10 does not have a connection with a helium supply source. The gas adsorption amount measurement apparatus 10 may include a plurality of the first connections 50, to which a plurality of adsorption gas sources can be connected. The gas adsorption amount measurement apparatus 10 may have a communication function, and some of the functions of the control unit 40 may be installed in an external server, a cloud, or the like.

Hereinafter, each component of the gas adsorption amount measurement apparatus 10 will be described in more detail. In the gas adsorption amount measurement apparatus 10, since the sample tubes 11, 12, and 13 have the same configuration, the details common to the sample tubes 11, 12, and 13 will be described by taking the sample tube 11 as an example.

The sample tube 11 is a glass tubular container with one end open and the other end closed. An example of the dimensions of the sample tube 11 is 1 cm in inner diameter and 20 cm in length. The sample tube 11 may be a quartz or metal container (the same applies to the reference tube 14). The shape of the sample tube 11 is not particularly limited, and may be a cylindrical shape with a constant tube diameter in the length direction, or may have a shape in which the bottom side where the sample 1 is housed is thicker than the opening side.

The sample tube 11 is connected to a port 56 of the piping section 16. The gas adsorption amount measurement apparatus 10 (housing) has the port 56 which is a connection port of the sample tube 11, and the opened end of the sample tube 11 is connected to the port 56. When the sample tube 11 is connected to the port 56, the sample tube 11 is connected to the adsorption gas supply source 100 and the exhaust pump 102 via the piping section 16. The gas adsorption amount measurement apparatus 10 has ports 57 and 58, which are the connection ports for the sample tubes 12 and 13. The ports 56, 57, and 58 are arranged horizontally in line with each other when the gas adsorption amount measurement apparatus 10 is in use, and the sample tubes 11, 12, and 13 are mounted at the same height.

The reference tube 14 is the same as the sample tube 11, as described above, and has substantially the same inner diameter. The volume of the reference tube 14 is the standard for calculating the volume of the free space of the sample tube 11. As will be described in detail later, the use of the reference tube 14 makes it possible to measure the reference volume of the free space of the sample tube 11 using adsorption gas without using helium. The gas adsorption amount measurement apparatus 10 has a port 59, which is the connection port for the reference tube 14. The port 59 is located at the same height as the ports 56, 57, and 58 in the horizontal direction in the use state of the gas adsorption amount measurement apparatus 10.

The reference tube 14 is placed together with the sample tubes 11, 12, and 13 so that it can be immersed in liquid nitrogen filled in the refrigerant container 18. Since the sample tubes 11, 12, and 13 and the reference tube 14 are attached at the same height, each tube is immersed in liquid nitrogen from the bottom to the same height. Similarly, the saturated vapor pressure tube 15 is connected to a port 60 of the piping section 16, and is immersed in the refrigerant 19 filled in the refrigerant container 18 together with the sample tube 11 and others.

The refrigerant container 18 is a container filled with the refrigerant 19 such as liquid nitrogen, and has an internal space that can accommodate the sample tubes 11, 12, and 13, the reference tube 14, and the saturated vapor pressure tube 15. The refrigerant container 18 is preferably a Dewar bottle with insulation. When nitrogen is used as the adsorption gas, liquid nitrogen (LN₂: 77 K) is generally used as the refrigerant 19. The device that maintains the sample tubes 11, 12, and 13, the reference tube 14, and the saturated vapor pressure tube 15 at a given temperature may have a thermostatic bath (adsorption temperature near room temperature) or a heater (high temperature adsorption temperature).

The gas adsorption amount measurement apparatus 10 includes, as described above, the pressure gauges 21, 22, 23, 24, and 25 for measuring the internal pressure of the sample tubes 11, 12, and 13, the reference tube 14, and the saturated vapor pressure tube 15. In the example illustrated in FIG. 1, the pressure gauge 21 is installed in a pipe 56a connecting the sample tube 11 and the manifold 17. In the pipe 56a, the switching valve 31 is installed on the manifold 17 side in relation to the pressure gauge 21. That is, the pressure gauge 21 is connected between the port 56 and the switching valve 31 in the pipe 56a, and measures the internal pressure of the sample tube 11 (including a part of the pipe 56a).

The pressure gauges 22, 23, 24, and 25, and the switching valves 32, 33, 34, and 35 are also installed in each of pipes 57a, 58a, 59a, and 60a connecting the sample tubes 12 and 13, the reference tube 14, and the saturated vapor pressure tube 15 to the manifold 17, similarly to the pressure gauge 21 and the switching valve 31. The switching valve 51 and a flow control valve 52 are installed on the pipe connecting the first connection 50 to the manifold 17, and the switching valve 54 and a flow control valve 55 are installed on the pipe connecting the second connection 53 to the manifold 17. The pressure gauge 20 is installed in the manifold 17 and measures the internal pressure of the manifold 17 (reference volume portion S).

The internal space of the manifold 17 surrounded by the switching valves 31, 32, 33, 34, 35, 51, and 54 is called the reference volume portion S as described above, and its volume serves as a reference when measuring the volume of the free space of the sample tube 11 and others. On the other hand, the internal spaces of the sample tubes 11, 12, 13, and the reference tube 14 are called free spaces. The volume of the free space of the sample tube 11 is precisely a volume obtained by adding the internal space of a part of the pipe 56a (from the switching valve 31 to the port 56) and the internal space of the sample tube 11.

The control unit 40 is configured to control the operation of the gas adsorption amount measurement apparatus 10 to perform the measurement of the gas adsorption amount. Specifically, the switching valve and flow control valve of the piping section 16 are controlled to supply adsorption gas at a predetermined relative pressure (P/P₀) to the sample tube 11, and the gas adsorption amount of the sample 1 contained in the sample tube 11 is calculated based on the measured value of the pressure gauge. A needle valve may be used as a flow control valve, or a resistance tube may be used instead of a flow control valve to adjust the flow rate of the adsorption gas. Prior to the measurement of the gas adsorption amount, the control unit 40 measures the reference volume of the free space of the sample tube 11 without the sample 1. The gas adsorption amount measurement apparatus 10 can measure the reference volume of the free space of the sample tubes 12 and 13 in parallel with the measurement of the sample tube 11.

The control unit 40 includes a computer including a processor 46, a memory 47, an input/output interface, and other elements. The processor 46 includes, for example, a CPU or a GPU, and reads and executes a processing program to implement a function of each processing unit described later. The memory 47 includes a nonvolatile memory such as a ROM, an HDD, or an SSD, and a volatile memory such as a RAM. The processing program is stored in the nonvolatile memory.

The gas adsorption amount measurement apparatus 10 may also include an input device for inputting information necessary for gas adsorption amount measurement, such as the mass of the sample, and a display device for displaying the measurement results of the gas adsorption amount and the like. Alternatively, a general-purpose keyboard, monitor, or the like may be connected to the gas adsorption amount measurement apparatus 10.

As illustrated in FIG. 1, the control unit 40 includes a reference volume measurement processing unit 41 that measures the reference volume of the free space of the sample tube 11 and the reference tube 14. The control unit 40 also includes a processing unit (a volume change amount calculation processing unit 42, a sample tube volume calculation processing unit 43, and an adsorption amount calculation processing unit 44) that performs the measurement of the gas adsorption amount of the sample using the reference volume measured by the function of the reference volume measurement processing unit 41. Furthermore, the control unit 40 may include a surface excess amount calculation processing unit 45 that calculates the surface excess adsorption amount of the sample. In the following example, nitrogen is used as the adsorption gas.

The control unit 40 is configured to measure, under calibration conditions, the reference volume Vd_{st,ads} of the free space of the sample tube 11 without the sample 1 and the reference volume Vd_{ref,ads} of the free space of the reference tube 14 using nitrogen. The measurement of the reference volume Vd_{st,ads} and Vd_{ref,ads} is performed by the function of the reference volume measurement processing unit 41. In the related-art measurement system, the reference volume is measured for the sample tube containing the sample using helium, which has difficulty adsorbing to the sample, but in the gas adsorption amount measurement apparatus 10, nitrogen is used to measure the reference volume Vd_{st,ads} of the free space of the sample tube 11 without the sample 1.

Here, calibration conditions mean the conditions for measuring the reference volumes Vd_{st,ads} and Vd_{ref,ads}, in which, for example, the liquid level of liquid nitrogen filled in the refrigerant container 18 and cooling the sample tube 11 and the reference tube 14 is in the first state (level A). As described in detail below, the reference volumes Vd_{st,RT} and Vd_{ref,RT} at room temperature are measured, which are then used to measure the reference volumes Vd_{st,ads} and Vd_{ref,ads} at the adsorption temperature. The difference in the reference volume between room temperature and adsorption temperature can be used for thermal transpiration correction (pressure correction). It is also possible to calculate the gas adsorption amount by using only the reference volumes Vd_{st,ads} and Vd_{ref,ads} (that is, without using the reference volumes Vd_{st,RT} and Vd_{ref,RT}).

The actual measurement conditions described below mean the conditions for measuring the gas adsorption amount of the sample, and in which, for example, the liquid level of liquid nitrogen, which is filled in the refrigerant container 18 and cools the sample tube 11 and the reference tube 14, is in the second state (level B). Generally, the measurement of the gas adsorption amount is performed a plurality of times at different relative pressures (P/P₀) of the nitrogen supplied to the sample tube 11, so there are a plurality of actual measurement conditions (liquid level of liquid nitrogen), such as levels B, C, and D. It is possible to make the liquid level of the liquid nitrogen the same level when measuring the reference volumes Vd_{st,ads} and Vd_{ref,ads} and when measuring the gas adsorption amount of the sample, but it is difficult to make it completely the same.

After measuring the reference volume Vd_{st,RT} of the free space of the sample tube 11 at room temperature (temperature T_{RT}), the sample tube 11 is immersed together with the reference tube 14 in liquid nitrogen filled in the refrigerant container 18 and cooled to temperature T_{ads}, and then the reference volume measurement processing unit 41 obtains the reference volume Vd_{st,ads} from the pressure change before and after cooling. Similarly, the reference volume measurement processing unit 41 measures the reference volume Vd_{ref,RT} of the free space of the reference tube 14 at room temperature (temperature T_{RT}) and measures the reference volume Vd_{ref,ads} using the reference volume Vd_{ref,RT}. The reference volume measurement processing unit 41 stores, for example, the reference volumes Vd_{ref,RT}, Vd_{ref,ads}, Vd_{st,RT}, Vd_{st,ads}, and temperatures T_{ads} and T_{RT} in the memory 47 for the sample tube 11.

The reference volume measurement processing unit 41 may calculate the reference volume Vd_{st,ads} as follows: the sample tube 11 and the reference tube 14 are immersed in liquid nitrogen and cooled to the temperature T_{ads}, nitrogen is introduced into the manifold 17 and the internal pressure is measured with the pressure gauge 20, nitrogen is introduced into the sample tube 11 and the internal pressure of the manifold 17 and the sample tube 11 is measured, and the reference volume Vd_{st,ads} is calculated based on each of these measured values. Similarly, the reference volume measurement processing unit 41 may calculate the reference volume Vd_{ref,ads} as follows: nitrogen is introduced from the manifold 17 into the reference tube 14 cooled to the temperature Tads, and the internal pressure of the manifold 17 and the reference tube 14 is measured to calculate the reference volume Vd_{ref,ads}.

The measurement of the gas adsorption amount by the functions of the volume change amount calculation processing unit 42, the sample tube volume calculation processing unit 43, and the adsorption amount calculation processing unit 44 is performed using the sample tube 11 for which the reference volume Vd_{st,ads} is calculated and the reference tube 14 for which the reference volume Vd_{ref,ads} is calculated. The volume change amount ΔVd_{ref(i)} and the volume Vd_{st,ads(i)} of the sample tube 11, which are necessary for the measurement of the gas adsorption amount and described below, are obtained under the actual measurement conditions where the sample tube 11 containing the sample 1 and the empty reference tube 14 are attached to the ports 56 and 59, respectively, and cooled by immersion in liquid nitrogen.

The control unit 40 is configured to calculate the volume change amount ΔVd_{ref(i)} of the free space of the reference tube 14 from the reference volume Vd_{ref,ads} of the free space of the reference tube 14 and the volume Vd_{ref,ads(i)} of the free space of the reference tube 14 under the actual measurement conditions of the gas adsorption amount. The calculation of the volume change amount ΔVd_{ref(i)} is performed by the function of the volume change amount calculation processing unit 42. By measuring the volume change amount ΔVd_{ref(i)} using the reference tube 14, the volume of the free space of the sample tube 11 can be accurately obtained under the actual measurement conditions in which the liquid level of the liquid nitrogen is different from the calibration condition.

The volume change amount calculation processing unit 42 measures the volume Vd_{ref,ads(i)} of the free space of the reference tube 14 at each measurement point of the gas adsorption amount, which is performed under different relative pressures of nitrogen (P/P₀), and calculates the volume change amount ΔVd_{ref(i)}. Since the liquid level of the liquid nitrogen in the refrigerant container 18 changes at each measurement point, the calculation of the volume change amount ΔVd_{ref(i)} will be performed at several different liquid levels. The volume change amount calculation processing unit 42, for example, reads the reference volume Vd_{ref,ads} from the memory 47 and calculates the volume change amount ΔVd_{ref(i)} based on the internal pressure of the manifold 17 and the reference tube 14. The volume change amount ΔVd_{ref(i)} is stored in the memory 47.

The control unit 40 is configured to calculate the volume Vd_{st,ads(i)} of the free space of the sample tube 11 under the actual measurement conditions from the volume change amount ΔVd_{ref(i)} and the reference volume Vd_{st,ads}. The calculation of the volume Vd_{st,ads(i)} is performed by the function of the sample tube volume calculation processing unit 43. Since the difference between the volume Vd_{st,ads(i)} and the reference volume Vd_{st,ads} can be regarded as equivalent to the volume change amount ΔVd_{ref(i)} of the reference tube 14, the volume Vd_{st,ads(i)} can be calculated by the following equation 1.

Vd_{st,ads(i)}=Vd_{st,ads}−ΔV_{ref(i)} [Equation 1]

The sample tube volume calculation processing unit 43 calculates the volume Vd_{st,ads(i)} for each measurement point of gas adsorption amount. That is, the calculation of the volume Vd_{st,ads(i)}, as well as the volume change amount ΔVd_{ref(i)}, is performed in a plurality of states with different liquid levels of liquid nitrogen. The sample tube volume calculation processing unit 43 reads the volume change amount ΔVd_{ref(i)} from the memory 47 and calculates the volume Vd_{st,ads(i)} using Equation 1 above. The volume Vd_{st,ads(i)} is stored in the memory 47 and used to calculate the gas adsorption amount of the sample 1. The volume Vd_{st,ads(i)} can be regarded as the reference volume of the sample tube 11, which is actually measured and corrected at each measurement point.

The control unit 40 is configured to calculate the gas adsorption amount of the sample 1 from the volume Vd_{st,ads(i)} of the free space of the sample tube 11 under the actual measurement conditions and the volume Vd_{sam,ads(i)} of the free space of the sample tube 11 containing the sample 1 under the actual measurement conditions. The calculation of the gas adsorption amount is performed by the function of the adsorption amount calculation processing unit 44. The same method as before can be applied to measure and calculate the gas adsorption amount of the sample 1, except that the volume Vd_{st,ads(i)} is used. The adsorption amount calculation processing unit 44 calculates the volume Vd_{st,ads(i)} at the measurement points where the relative pressure (P/P₀) of nitrogen supplied to the sample tube 11 and others is different, and calculates the adsorption isotherm of the sample 1.

The control unit 40 may be configured to calculate the surface excess adsorption amount by eliminating the previously determined volume of the sample 1 from the volume of the free space of the sample tube 11 determined in the process of calculating the gas adsorption amount. The calculation of the amount of surface excess adsorption amount is performed by the function of the surface excess amount calculation processing unit 45. In the gas adsorption amount measurement apparatus 10, the gas adsorption amount of the sample 1 is measured using the reference volume Vd_{st,ads} of the free space of the sample tube 11 without the sample 1, so the adsorption amount is the net adsorption amount that takes the volume of the sample 1 into account. According to the gas adsorption amount measurement apparatus 10, the surface excess adsorption amount measured by a general measurement apparatus can be easily calculated, for example, by subtracting the volume of sample 1 from the volume Vd_{sam,ads(i)}.

The surface excess amount calculation processing unit 45 calculates the volume Vd′_{sam,ads(i)} of the free space of the sample tube 11, which excludes the volume of the sample 1, according to Equation 2 below:

$${Vd}_{st , ads ( i )}^{′} = {Vd}_{st , adn ( i )} - Δ {V}_{ref ( i )} - ( \frac{SW}{ρ} ) ( \frac{{T}_{RT}}{{T}_{ads}} ) \qquad [ Equation 2 ]$$

wherein SW is the mass (g) of the sample 1 and ρ is the true density (g/cm³) of the sample 1. For the true density of sample 1, for example, literature values or values measured by a true density measurement apparatus can be applied. The mass and true density of the sample 1 are, for example, entered into the system beforehand using an input device and stored in the memory 47. The surface excess amount calculation processing unit 45 reads the mass and true density of the sample 1 from the memory 47 and calculates the surface excess adsorption amount using Equation 2.

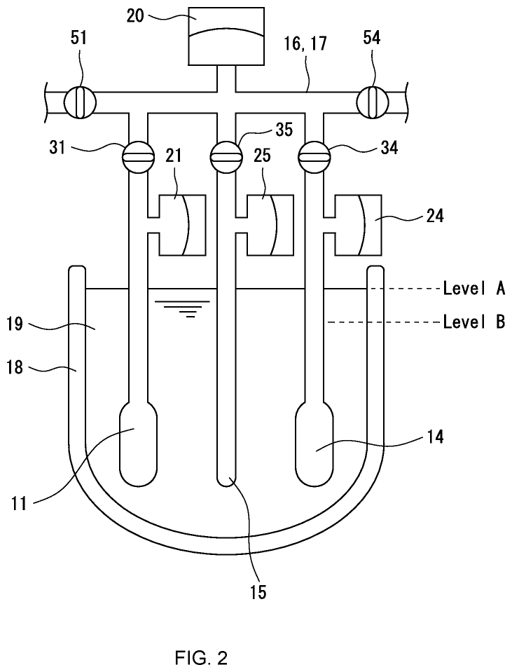

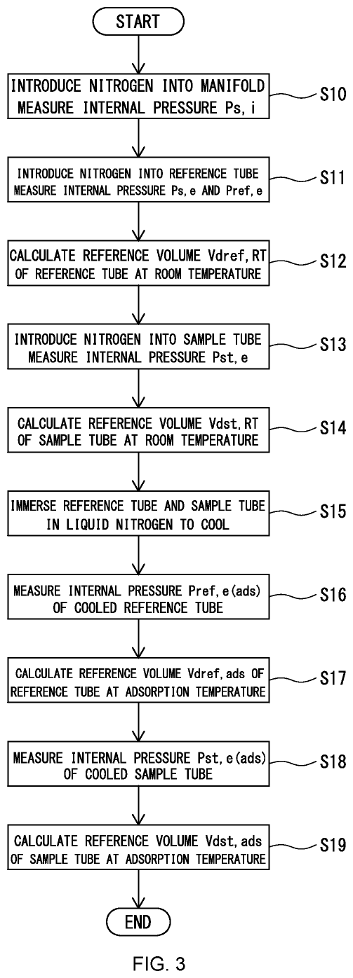

The method for measuring the gas adsorption amount using the gas adsorption amount measurement apparatus 10 is described in detail below with reference to FIGS. 2 to 4. FIG. 2 is a simplified version of the configuration diagram in FIG. 1 and illustrates the method for measuring the gas adsorption amount. FIG. 3 is a flowchart illustrating an example of the procedure for measuring the reference volume Vd_{st,ads} of the free space of the sample tube 11 and the reference volume Vd_{ref,ads} of the free space of the reference tube 14.

As illustrated in FIG. 2, when measuring the gas adsorption amount of the sample 1 by the gas adsorption amount measurement apparatus 10, the sample tube 11, the reference tube 14, and the saturated vapor pressure tube 15 containing the sample 1 (not shown in FIG. 2), are attached to the piping section 16. The temperature of the manifold 17, which is the reference volume portion S (volume Vs), may be maintained at temperature Tₘ by the second device above, or at room temperature T_{RT}. In the following, the temperature of the manifold 17 is assumed to be Tₘ.

The gas adsorption amount measurement apparatus 10 measures the reference volume Vd_{st,ads} of the free space of the sample tube 11 using nitrogen prior to measuring the gas adsorption amount of the sample 1. The measurement of the reference volume Vd_{st,ads} is performed using the empty sample tube 11 without the sample 1. At the same time as measuring the reference volume Vd_{st,ads}, the reference volume Vd_{ref,ads} of the reference tube 14 is measured. The reference volumes Vd_{st,ads} and Vd_{ref,ads} are measured with the sample tube 11 and the reference tube 14 immersed in liquid nitrogen; that is, at the adsorption temperature. The reference conditions for measuring the reference volumes Vd_{st,ads} and Vd_{ref,ads} include, for example, the liquid level of liquid nitrogen at level A.

The measurement of the reference volumes Vd_{st,ads} and Vd_{ref,ads} need not be performed every time the gas adsorption amount is measured, but may be performed only once for the sample tube 11. Alternatively, it may be performed periodically, such as once every predetermined period of time (for example, one year) or once every predetermined number of measurements (for example, every 100 measurements). The prior-art measurement of the reference volume using helium is carried out every time the gas adsorption amount is measured, but the measurement method of the present disclosure can significantly reduce the number of measurements of the reference volume Vd_{st,ads} and shorten the measurement time.

In the example illustrated in FIG. 3, the reference volumes Vd_{st,ads} and Vd_{ref,ads} at the adsorption temperature (for example, at the liquid level A) are calculated using the reference volumes Vd_{st,RT} and Vd_{ref,RT} of the sample tube 11 and the reference tube 14 measured at room temperature. In this case, thermal transpiration correction can be performed, which further improves the measurement accuracy.

In the example illustrated in FIG. 3, first, the reference volume Vd_{ref,RT} of the free space of the reference tube 14 at room temperature (temperature T_{RT}) is measured (S10 to S12). The reference volume Vd_{st,RT} of the sample tube 11 may be measured first.

First, the system including the internal spaces of the manifold 17, the sample tube 11, and the reference tube 14 is evacuated by the exhaust pump 102, and the decrease of the degree of vacuum to the measurement lower limit or less of each pressure gauge is confirmed. Thereafter, all the switching valves are closed, and all the pressure gauges are adjusted to zero. Subsequently, the switching valve 51 is opened to introduce nitrogen into the manifold 17, which is the reference volume portion S (volume Vs), and the switching valve 51 is closed when the internal pressure of the manifold 17 reaches a predetermined value. Thereafter, when the pressure is stabilized, the internal pressure P_{s,i} of the manifold 17 is measured by the pressure gauge 20 (S10).

Next, the switching valve 34 corresponding to the reference tube 14 is opened to introduce the nitrogen in the manifold 17 into the reference tube 14. After a lapse of a sufficient time (for example, 5 seconds) for diffusing nitrogen into the reference tube 14, the switching valve 34 is closed, and the internal pressure P_{s,e} of the manifold 17 is measured by the pressure gauge 20 when the pressure is stabilized, and the internal pressure P_{ref,e} of the reference tube 14 is measured by the pressure gauge 24 (S11).

From the pressure measured in S10 and 11, the volume of the manifold 17 Vs, and the temperature Tₘ, the reference volume Vd_{ref,RT} of the free space of reference tube 14 at room temperature is calculated using the following equations (S12). The mass balance before and after the introduction of nitrogen into the reference tube 14 is expressed by Equation 3, and the reference volume Vd_{ref,RT} at room temperature is calculated by Equation 4.

$$\frac{{P}_{s , i} Vs}{{T}_{m}} = \frac{{P}_{s , e} Vs}{{T}_{m}} + \frac{{P}_{ref , e} {Vd}_{ref , RT}}{{T}_{RT}} \qquad [ Equation 3 ]$$

$${Vd}_{ref , RT} = ( \frac{{P}_{s , i} - {P}_{ref , e}}{{P}_{ref , e}} ) ( \frac{{T}_{RT}}{{T}_{m}} ) Vs \qquad [ Equation 4 ]$$

The reference volume Vd_{ref,RT} is the reference value for the free space of the reference tube 14 and is used to calculate the volume of the free space of the sample tube 11.

Subsequently, for the sample tube 11, the switching valve 31 corresponding to the sample tube 11 is opened to introduce nitrogen in the manifold 17 into the sample tube 11, and the switching valve 31 is closed and the internal pressure P_{st,e} of the sample tube 11 is measured with the pressure gauge 21 (S13) when the pressure is stabilized. Then, using the same equation as Equation 4, the reference volume Vd_{st,RT} of the free space of the sample tube 11 at room temperature is calculated (S14).

Next, the reference tube 14 and the sample tube 11 are immersed in liquid nitrogen filled in the refrigerant container 18 and cooled to temperature Td_{ads} (S15). At this time, the pressure in the sample tube 11 and the reference tube 14 changes. When the pressure is stabilized, the internal pressure P_{ref,e(ads)} of the reference tube 14 is measured by the pressure gauge 24 (S16), and the reference volume Vd_{ref,ads} of the free space of the reference tube 14 at the adsorption temperature (for example, at the liquid level A) is calculated by the following equation (S17). The mass balance due to the pressure change before and after cooling of the reference tube 14 is expressed by Equation 5, and the reference volume Vd_{ref,ads} at the adsorption temperature is calculated by Equation 6.

$${P}_{ref , e} {Vd}_{ref , RT} = {P}_{ref , e ( ads )} {Vd}_{ref , ads} \qquad [ Equation 5 ]$$

$${Vd}_{ref , ads} = \frac{{P}_{ref , e}}{{P}_{ref , e ( ads )}} {Vd}_{ref , RT} \qquad [ Equation 6 ]$$

Subsequently, for the sample tube 11, when the pressure is stabilized, the internal pressure P_{st,e(ads)} of the sample tube 11 is measured by the pressure gauge 21 (S18), and the reference volume Vd_{st,ads} of the free space of the sample tube 11 at the adsorption temperature is calculated by the same formula as Equation 6 (S19). The reference volume of the sample tubes 12 and 13 can also be measured in parallel with the measurement of the sample tube 11.

The procedures S10 through S19 are performed by the functions of the reference volume measurement processing unit 41. The reference volume measurement processing unit 41 stores the reference volume Vd_{ref,ads}, Vd_{st,ads}, and temperature T_{ads} in the memory 47, for example, for the sample tube 11. The reference volume measurement processing unit 41 may also store the reference volumes Vd_{ref,RT}, Vd_{st,RT} and temperature T_{RT} in the memory 47.

When other refrigerant 19 such as liquid argon is used to measure the gas adsorption amount, it is necessary to use liquid argon to measure the reference volumes Vd_{ref,ads} and Vd_{st,ads}. In this case, the reference volume measurement processing unit 41 adds a library for liquid argon (for example, Vd_{ref,RT}, Vd_{ref,ads(Ar)}, Vd_{st,RT}, Vd_{st,ads(Ar)}, temperature T_{ads(Ar)}) separately from the library for liquid nitrogen (for example, Vd_{refRT},Vd_{ref,ads(N2)}, Vd_{st,RT}, Vd_{st,ads(N2)}, temperature T_{ads(N2)}) for the sample tube 11.

When the reference tube 14 is damaged or lost, the reference volume Vd_{ref,RT} and Vd_{ref,ads} can be measured for a new reference tube 14, and the difference between the measured values and those of the related-art reference tube 14 can be applied to the reference volume of the measured sample tube. That is, there is no need to measure the reference volume of the sample tube again.

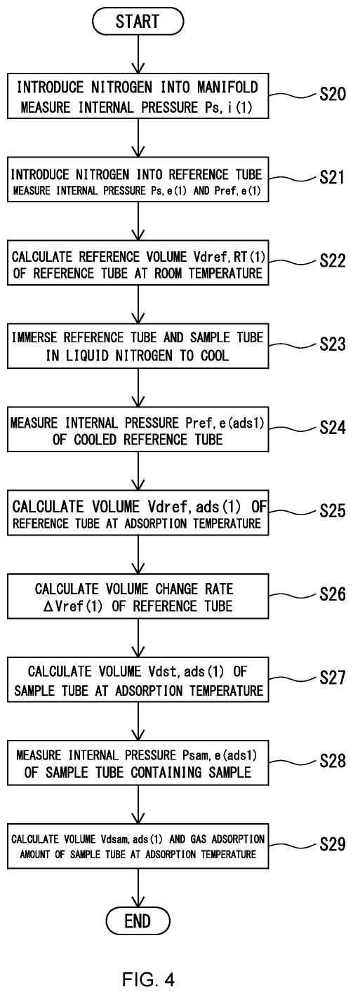

FIG. 4 is a flowchart illustrating an example of the procedure for measuring the gas adsorption amount of the sample 1. The measurement of the gas adsorption amount of sample 1 is performed by the function of the adsorption amount calculation processing unit 44. FIG. 4 illustrates the procedure for measuring the net adsorption amount, where the volume of sample 1 is taken into account. For example, the surface excess adsorption amount can be easily calculated by subtracting the volume of sample 1 from the volume Vd_{sam,ads(i)}. The calculation of the amount of surface excess adsorption amount is performed by the function of the surface excess amount calculation processing unit 45.

In general, when measuring the gas adsorption amount of the sample 1, the sample 1 is pretreated. The pretreatment is performed, for example, by placing the sample 1 in the sample tube 11 and heating it under vacuum or inert gas flow to a temperature where the physical properties do not change. The sample tube 11 containing the pretreated sample 1 is connected to the port 56, and the following measurement procedure is started.

First, the system including the internal spaces of the manifold 17, sample tube 11, reference tube 14, and saturated vapor pressure tube 15 is evacuated by the exhaust pump 102, and the decrease of the degree of vacuum to the measurement lower limit or less of each pressure gauge is confirmed. Thereafter, all the switching valves are closed, and all the pressure gauges are adjusted to zero. Subsequently, the switching valve 51 is opened to introduce nitrogen into the manifold 17, and the switching valve 51 is closed when the internal pressure of the manifold 17 reaches a predetermined value. Thereafter, when the pressure is stabilized, the internal pressure P_{s,i(1)} of the manifold 17 is measured by the pressure gauge 20 (S20).

Next, nitrogen in the manifold 17 is introduced into the reference tube 14, and after a lapse of a predetermined time, the switching valve 34 is closed. When the pressure is stabilized, the internal pressure P_{s,e(1)} of the manifold 17 is measured by the pressure gauge 20, and the internal pressure P_{ref,e(1)} of the reference tube 14 (S21) is measured by the pressure gauge 24. The volume Vd_{ref,RT(1)} of the free space of the reference tube 14 at room temperature is calculated using Equation 7 below (S22). When it is confirmed that Vd_{ref,RT(1)}=Vd_{ref,RT}, the reference tube 14 is the same as the reference tube 14 used for measuring the reference volume of the sample tube 11.

$${Vd}_{ref , RT ( 1 )} = ( \frac{{P}_{s , i ( 1 )} - {P}_{ref , e ( 1 )}}{{P}_{ref , e ( 1 )}} ) ( \frac{{T}_{RT}}{{T}_{m}} ) Vs \qquad [ Equation 7 ]$$

When Vd_{ref,RT(1)} and Vd_{ref,RT} do not match, the error is due to, for example, the difference in room temperature T_{RT} at the time of each measurement, but is usually negligible. By storing the room temperature T_{RT} at the time of the reference volume measurement and comparing it with the room temperature T_{RT} at the time of the volume Vd_{ref,RT(1)} measurement, it is also possible to compensate for errors due to changes in the room temperature T_{RT}.

Next, the reference tube 14, together with the sample tube 11, is immersed in liquid nitrogen filled in the refrigerant container 18 and cooled to the temperature Td_{ads} (S23). When the pressure is stabilized, the internal pressure P_{ref,e(ads1)} of the reference tube 14 is measured by the pressure gauge 24 (S24), and the volume Vd_{ref,ads(1)} of the free space of the reference tube 14 at the adsorption temperature is calculated using Equation 8 below (S25). The first actual measurement condition when measuring the volume Vd_{ref,ads(1)} is that, for example, the liquid level of liquid nitrogen is at the level B.

$${Vd}_{ref , ads ( 1 )} = \frac{{P}_{ref , e ( 1 )}}{{P}_{ref , e ( ads 1 )}} {Vd}_{ref , RT ( 1 )} \qquad [ Equation 8 ]$$

At this time, Vd_{ref,ads(1)}≠Vd_{ref,ads}, and this difference is due to the difference in liquid level of liquid nitrogen (for example, the difference between the liquid levels A and B). Then, the volume change rate ΔV_{ref(1)} of the free space of the reference tube 14 is calculated by the following Equation 9 (S26). The procedure of S26 is performed by the function of the volume change amount calculation processing unit 42.

ΔV_{ref(1)}=Vd_{ref,ads}−Vd_{ref,ads(1)} [Equation 9]

Next, from the volume change amount ΔVd_{ref(1)} and the reference volume Vd_{st,ads} of the sample tube 11, the volume Vd_{st,ads(1)} of the free space of the sample tube 11 at the adsorption temperature is calculated (for example, at the liquid level B) (S27). The calculation of the volume Vd_{st,ads(1)} is performed by the function of the sample tube volume calculation processing unit 43. Since the difference between the volume Vd_{st,ads(1)} and the reference volume Vd_{st,ads(1)} can be regarded as equivalent to the volume change amount ΔVd_{ref(1)} of the reference tube 14, the volume Vd_{st,ads(1)} can be calculated by the following Equation 10.

Vd_{st,ads(1)}=Vd_{st,ads}−ΔV_{ref(1)} [Equation 10]

Next, nitrogen is introduced into the sample tube 11 containing the sample 1, and the switching valve 31 is closed to allow nitrogen to be adsorbed to the sample 1. It takes a predetermined amount of time for nitrogen to be adsorbed to the sample 1 and for the internal pressure of the sample tube 11 to reach equilibrium, and whether or not equilibrium has been reached is determined by continuously monitoring the pressure change. In the equilibrium state, the internal pressure P_{sam,e(ads1)} of the sample tube 11 is measured by the pressure gauge 21 (S28), and the volume of the free space Vd_{sam,ads(1)} of the sample tube 11 is calculated, thereby calculating the gas adsorption amount of the sample 1 under the first actual measurement condition (S29).

The adsorption amount calculation processing unit 44 calculates the adsorption isotherm of sample 1 by changing the relative pressure (P/P₀) of the nitrogen supplied to the sample tube 11 and others. That is, the procedures from S20 to S29 are performed under a plurality of actual measurement conditions with different relative pressures of nitrogen (P/P₀).

In the examples illustrated in FIGS. 3 and 4, the reference volumes Vd_{st,RT} and Vd_{ref,RT} at room temperature were measured, but the gas adsorption amount may be calculated using only the reference volumes Vd_{st,ads} and Vd_{ref,ads} at the adsorption temperature without measuring the reference volumes. Specifically, the sample tube 11 and the reference tube 14 are immersed in liquid nitrogen and cooled to temperature Tads, then nitrogen is introduced into the manifold 17 and the internal pressure is measured. Thereafter, nitrogen is introduced into the reference tube 14 to measure the internal pressure of the manifold 17 and the reference tube 14, and the reference volume Vd_{ref,ads} is calculated based on the respective measured values (the same applies to the sample tube 11).

As described above, according to the gas adsorption amount measurement apparatus 10 and the measurement method described above, the reference volume Vd_{st,ads} of the free space of the sample tube 11 can be measured without using helium, using adsorption gas instead, and the volume can be used to measure the gas adsorption amount with high accuracy. It has been demonstrated that the gas adsorption amount calculated from the reference volume Vd_{st,ads} measured using adsorption gas is equivalent to the gas adsorption amount calculated from the reference volume measured using helium. That is, the measurement method described above can measure the gas adsorption amount with the same level of accuracy as the measurement method using helium in the related art. In addition, the measurement method described above eliminates the need to measure the reference volume Vd_{st,ads} every time the gas adsorption amount is measured, as in the related art, thus shortening the measurement time.

### REFERENCE SIGNS LIST

1, 2, 3 Sample
10 Gas adsorption amount measurement apparatus
11, 12, 13 Sample tubes
14 Reference tube
15 Saturated vapor pressure tube
16 Piping section
17 Manifold
18 Refrigerant container
19 Refrigerant
20, 21, 22, 23, 24, 25 Pressure gauges
31, 32, 33, 34, 35, 51, 54 Switching valves
40 Control unit
41 Reference volume measurement processing unit
42 Volume change amount calculation processing unit
43 Sample tube volume calculation processing unit
44 Adsorption amount calculation processing unit
45 Surface excess amount calculation processing unit
46 Processor
47 Memory
50 First connection
52, 55 Flow control valves
53 Second connection
56, 57, 58, 59, 60 Ports
56a, 57a, 58a, 59a, 60a Pipes
100 Adsorption gas supply source
101 Supply pipe
102 Exhaust pump
103 Exhaust pipe

1. A gas adsorption amount measurement apparatus that comprises at least one sample tube and measures the gas adsorption amount of a sample contained in the sample tube by supplying an adsorption gas to the sample tube, comprising:
a reference tube for determining the volume of the free space of a sample tube;
a piping section to which the sample tube, the reference tube, and the supply pipe of the adsorption gas are connected;
a pressure gauge for measuring the pressure of the piping section, the sample tube, and the reference tube;
a device for maintaining the temperature of the sample tube and the reference tube at a predetermined temperature; and
a control unit,
wherein the control unit is configured to measure the reference volume Vd_{st,ads} of the free space of the sample tube without the sample and the reference volume Vd_{ref,ads} of the free space of the reference tube under calibration conditions using the adsorption gas,
calculate the volume change amount ΔVd_{ref(i)} from the reference volume Vd_{ref,ads} and the volume Vd_{ref,ads(i)} of the free space of the reference tube under the actual measurement conditions of the gas adsorption amount,
calculate the volume Vd_{st,ads(i)} of the free space of the sample tube under the actual measurement conditions from the volume change amount ΔVd_{ref(i)} and the reference volume Vd_{st,ads}, and
calculate the gas adsorption amount of the sample under the actual measurement conditions from the volume Vd_{st,ads(i)} and the volume Vd_{sam,ads(i)} of the free space of the sample tube containing the sample under the actual measurement conditions.

2. The gas adsorption amount measurement apparatus according to claim 1, which comprises a plurality of the sample tubes, and
wherein the control unit calculates the reference volume Vd_{st,ads} for each of the plurality of sample tubes using one reference tube.

3. The gas adsorption amount measurement apparatus according to claim 1, wherein the control unit is configured to calculate the surface excess adsorption amount by eliminating the previously determined volume of the sample from the volume of the free space of the sample tube determined in the process of calculating the gas adsorption amount.

4. A method for measuring a gas adsorption amount using at least one sample tube and a reference tube for determining the volume of the free space of the sample tube, comprising:
measuring the reference volume Vd_{st,ads} of the free space of the sample tube without the sample and the reference volume Vd_{ref,ads} of the free space of the reference tube under calibration conditions using an adsorption gas;
calculating the volume change amount ΔVd_{ref(i)} from the reference volume Vd_{ref,ads} and the volume Vd_{ref,ads(i)} of the free space of the reference tube under the actual measurement conditions of the gas adsorption amount;
calculating the volume Vd_{st,ads(i)} of the free space of the sample tube under the actual measurement conditions from the volume change amount ΔVd_{ref(i)} and the reference volume Vd_{st,ads}; and
calculating the gas adsorption amount of the sample under the actual measurement conditions from the volume Vd_{st,ads(i)} and the volume Vd_{sam,ads(i)} of the free space of the sample tube containing the sample under the actual measurement conditions.
